(19) United States
(12) Patent Application Publication
(10) Pub. No.: US 2026/0251514 A1
(43) Pub. Date: Aug. 27, 2026

(54) MEASUREMENT APPARATUS FOR REINFORCING MATERIAL CONDITIONS, MEASUREMENT METHOD FOR REINFORCING MATERIAL CONDITIONS, AND PRODUCTION METHOD OF MEASUREMENT APPARATUS FOR REINFORCING MATERIAL CONDITIONS

(71) Applicant: SUMITOMO ELECTRIC INDUSTRIES, LTD., Osaka (JP)

(72) Inventors: Masashi OIKAWA, Osaka (JP); Rei KASAHARA, Osaka (JP); Yuka KISHIMOTO, Osaka (JP); Yoshiyuki MATSUBARA, Osaka (JP); Daisuke KUBODUKA, TOKYO (JP); Satoshi TANAKA, TOKYO (JP); Kazumasa OKUBO, Tokyo (JP); Michio IMAI, Tokyo (JP); Naoki SOGABE, Tokyo (JP)

(21) Appl. No.: 19/545,771

(22) Filed: Feb. 20, 2026

(30) Foreign Application Priority Data
Feb. 26, 2025 (JP) 2025-029003

(51) Int. Cl. G01L 1/24; G01K 1/08; G01K 11/32; G02B 6/44

(52) U.S. Cl. CPC G01L 1/242; G02B 6/4431; G02B 6/4432; G01K 1/08; G01K 11/32

(57) ABSTRACT

Measurement apparatus for reinforcing material conditions is provided and includes optical fibers with a protective material configured to be arranged along a surface of a slope where a plurality of reinforcing materials are secured to intersect with the slope, and configured to pass through a region where the plurality of reinforcing materials are arranged. The optical fibers with a protective material include a linear protective material and the first optical fiber. At least a portion of the first optical fiber is arranged along the longitudinal direction of the linear protective material. At least a portion of a surface of the first optical fiber is covered with the linear protective material.

### CROSS-REFERENCE TO RELATED APPLICATIONS

This application is based on and claims priority to Japanese Patent Application No. 2025-029003 filed on Feb. 26, 2025, the entire contents of which are incorporated herein by reference.

### TECHNICAL FIELD

The present disclosure relates to measurement apparatus for reinforcing material conditions, a measurement method for reinforcing material conditions, and a production method of the measurement apparatus for reinforcing material conditions.

### BACKGROUND

Japanese Laid-Open Patent Application Publication No. 2002-257654 discloses a tension force measurement apparatus configured to measure a tension force applied to a tension member fixed to a bearing member via a fixing member at an end of a concrete member. This tension force measurement apparatus includes: a hydraulic separator configured to separate the fixing member and the bearing member from each other; a hydraulic supply configured to supply hydraulic oil to the hydraulic separator; a hydraulic oil amount detector configured to measure a change in an amount of hydraulic oil supplied from the hydraulic supply to the hydraulic separator; and a pressure meter configured to measure a hydraulic oil pressure applied to the hydraulic separator.

### SUMMARY

Measurement apparatus for reinforcing material conditions of the present disclosure includes: an optical fiber with a protective material arranged on a surface of a slope on which a plurality of reinforcing materials are secured to intersect with the slope, and configured to pass through a region where the plurality of reinforcing materials are arranged. The optical fiber with the protective material includes a linear protective material and a first optical fiber. At least a portion of the first optical fiber is arranged along the longitudinal direction of the linear protective material. At least a portion of a surface of the first optical fiber is covered with the linear protective material.

### BRIEF DESCRIPTION OF THE DRAWINGS

FIG. 1 is a perspective diagram of measurement apparatus for reinforcing material conditions according to an embodiment of the present disclosure, with the measurement apparatus for reinforcing material conditions being arranged on a slope.

FIG. 2 is a schematic cross-sectional diagram taken along the line B-B in FIG. 1.

FIG. 3A is a schematic cross-sectional diagram of an optical fiber with a protective material in a plane orthogonal to the longitudinal direction of the optical fiber with the protective material.

FIG. 3B is a schematic cross-sectional diagram of the optical fiber with the protective material in the plane orthogonal to the longitudinal direction of the optical fiber with the protective material.

FIG. 3C is a schematic cross-sectional diagram of the optical fiber with the protective material in the plane orthogonal to the longitudinal direction of the optical fiber with the protective material.

FIG. 4 is an explanatory diagram of a fixing member.

### DETAILED DESCRIPTION

A plurality of reinforcing materials are arranged to intersect with a slope.

The reinforcing materials, into which a tension force is introduced, apply a compressive force to the natural ground including a slope, thereby maintaining the shape of the slope and preventing a landslide and the like. However, after arrangement of the reinforcing materials, the tension force introduced into the reinforcing materials may disadvantageously decrease. From the viewpoint of enhancing the shape stability of a slope and continuously preventing a landslide and the like, the tension force introduced into the reinforcing materials is measured, for example, as disclosed in Japanese Laid-Open Patent Application Publication No. 2002-257654.

However, when using conventional tension force measurement apparatuses, significant effort may be required to measure the tension force. In addition, it is time-consuming and laborious to measure the tension force and the like of a plurality of reinforcing materials.

The present disclosure provides measurement apparatus for reinforcing material conditions configured to readily measure the conditions of a plurality of reinforcing materials arranged on a slope.

Embodiments of the present disclosure will be described below.

### Description of Embodiments of the Present Disclosure

First, embodiments of the present disclosure will be described. In the following description, the same or corresponding components are denoted by the same reference signs, and thus duplicate descriptions thereof are omitted.
(1) Measurement apparatus for reinforcing material conditions according to an aspect of the present disclosure includes: an optical fiber with a protective material arranged on a surface of a slope on which a plurality of reinforcing materials are secured to intersect with the slope, and configured to pass through a region where the plurality of reinforcing materials are arranged, wherein the optical fiber with the protective material includes a linear protective material and a first optical fiber, at least a portion of the first optical fiber is arranged along the longitudinal direction of the linear protective material, and at least a portion of a surface of the first optical fiber is covered with the linear protective material.

The optical fiber with the protective material arranged on the surface of the slope included in the measurement apparatus for reinforcing material conditions according to the aspect of the present disclosure is arranged to pass through the region where the plurality of reinforcing materials are arranged. When scattered light is oscillated in the first optical fiber with the protective material, it is possible to measure strain distributions along the longitudinal direction of the first optical fiber. Since the axial force and the tension force of the plurality of reinforcing materials are reflected in the measured strain distributions, the axial force and the tension force of the reinforcing materials can be readily measured simply by oscillating scattered light in the first optical fiber.

When the portion of the surface of the first optical fiber with the protective material is covered with the protective material, the protective material can protect the first optical fiber thereby preventing damage or the like of the first optical fiber.
(2) In the above (1), the protective material may include a metal wire.

By using a metal wire as the protective material, it is possible to enhance the toughness of the protective material, i.e., the metal wire, and especially to prevent damage or the like of the protective material or the first optical fiber arranged on the protective material.
(3) In the above (2), the metal wire may include stranded individual wires, and the first optical fiber may be arranged in a groove between the stranded wires.

When the metal wire includes the stranded individual wires, the metal wire can be readily bent. Therefore, it is possible to readily cause the optical fiber with the protective material to deform in accordance with the arrangement of the plurality of reinforcing materials, and readily arrange the optical fiber with the protective material in the region where the plurality of reinforcing materials are arranged.

In addition, by arranging the first optical fiber in the groove between the stranded wires, it is possible to protect the first optical fiber thereby preventing damage or the like of the first optical fiber.
(4) In any one of the above (1) to (3), the measurement apparatus for reinforcing material conditions includes a plurality of optical fibers with a protective material.

By providing the plurality of optical fibers with a protective material, it is possible to measure one or more selected data of the axial force and the tension force of a large number of the reinforcing materials.
(5) In any one of the above (1) to (4), a bearing plate may be included at the end of the plurality of reinforcing materials, and the optical fiber with the protective material may be arranged to pass through a region between the slope and the bearing plate.

By arranging the optical fiber with the protective material to pass through the region between the bearing plate and the slope, the first optical fiber with the protective material can strongly receive the axial force and the tension force of the reinforcing materials through the bearing plate, thereby performing measurement with especially high accuracy.
(6) In any one of the above (1) to (5), at least a portion of the plurality of reinforcing materials may be a reinforcing material including a second optical fiber arranged along the longitudinal direction of the reinforcing material.

When the measurement apparatus for reinforcing material conditions according to the aspect of the present disclosure includes the second optical fiber arranged along the longitudinal direction of the reinforcing material, it is possible to measure the axial force and the like of the reinforcing materials with higher accuracy.

By measuring the axial force or the tension force of the reinforcing materials using the first optical fiber and the second optical fiber in combination, it is possible to measure and detect the conditions of the reinforcing materials, abnormality of the slope, and the like with higher accuracy, while reducing the labor required for the measurement.
(7) In any one of the above (1) to (6), the measurement apparatus for reinforcing material conditions may further include a measurement function including a scattered light measurement device connected to the first optical fiber.

When the measurement apparatus for reinforcing material conditions according to the aspect of the present disclosure includes the measurement function including the scattered light measurement device connected to the first optical fiber, it is possible to readily measure strain and the like along the longitudinal direction of the first optical fiber.
(8) In the above (7), the measurement apparatus for reinforcing material conditions may further include a function configured to locate a position of the plurality of reinforcing materials on the first optical fiber based on strain distributions measured by the measurement device along the longitudinal direction of the first optical fiber.

In the strain distributions measured by the first optical fiber with the protective material, the strain increases at a position of the region where the reinforcing materials are arranged. Thus, the strain distributions enable the position of each reinforcing material to be located. The function configured to locate the position locates the position of the reinforcing materials based on the strain distributions along the longitudinal direction of the first optical fiber, thereby accurately locating the axial force and the tension force of the reinforcing materials.
(9) In the above (7) or (8), the measurement device may be configured to perform a plurality of times of measurements at predetermined intervals, and the measurement apparatus for reinforcing material conditions may further include a calculator configured to determine temporal changes of one or more selected data of the axial force and the tension force of the plurality of reinforcing materials based on changes in strain distributions measured by the measurement device along the longitudinal direction of the first optical fiber.

When the measurement device performs a plurality of times of measurements and the calculator calculates, based on the changes in the strain distributions, the temporal changes of one or more selected data of the axial force and the tension force of the plurality of reinforcing materials, it is possible to observe the changes in the axial force and the like of the reinforcing materials.
(10) In the above (9), the measurement apparatus for reinforcing material conditions may further include a function configured to issue an alarm when the temporal changes in one or more selected data of the axial force and the tension force of the plurality of reinforcing materials calculated by the calculator exceed the predetermined range.

When the measurement apparatus for reinforcing material conditions according to the aspect of the present disclosure includes the function configured to issue an alarm, it is possible to rapidly notify an operator, a manager, or the like of a problem with the conditions of the axial force or the tension force of the reinforcing materials.
(11) A measurement method for reinforcing material conditions according to another aspect of the present disclosure includes: the first measurement process of oscillating scattered light from a measurement device using scattered light emitted into a first optical fiber with a protective material arranged on a surface of a slope on which a plurality of reinforcing materials are secured and to pass through a region where the plurality of reinforcing materials are arranged, thereby measuring one or more selected data of the axial force and the tension force of the plurality of reinforcing materials, wherein the first optical fiber with the protective material includes a linear protective material, at least a portion of the first optical fiber is arranged along the longitudinal direction of the linear protective material, and at least a portion of the surface of the first optical fiber is covered with the linear protective material.

According to the measurement method for reinforcing material conditions according to another aspect of the present disclosure, it is possible to oscillate scattered light in the first optical fiber with the protective material arranged on the surface of the slope and to pass through the region where the plurality of reinforcing materials are arranged. By oscillating scattered light in the first optical fiber with the protective material, it is possible to measure the strain distributions along the longitudinal direction of the first optical fiber. Since the axial force and the tension force of the plurality of reinforcing materials are reflected in the measured strain distributions, the axial force and the tension force of the reinforcing materials can be readily measured simply by oscillating scattered light in the first optical fiber.

When the portion of the surface of the first optical fiber with the protective material is covered with the protective material, the protective material can protect the first optical fiber thereby preventing damage or the like of the first optical fiber.
(12) In the above (11), at least a portion of the plurality of reinforcing materials may be a reinforcing material including a second optical fiber arranged along the longitudinal direction of the reinforcing material, and the measurement method for reinforcing material conditions may further include, when measured values obtained in the first measurement process exceed the predetermined range, a second measurement process of one or more selected data of the axial force and the tension force along the longitudinal direction of the reinforcing material using the second optical fiber is available.

By measuring the axial force and the like along the longitudinal direction of the reinforcing materials in the second measurement process, it is possible to especially accurately evaluate the axial force and the like of the reinforcing materials.
(13) In the above (11), at least a portion of the plurality of reinforcing materials may be a reinforcing material including a second optical fiber arranged along the longitudinal direction of the reinforcing material, the measurement method for reinforcing material conditions may further include a second measurement process of one or more selected data of the axial force and the tension force along the longitudinal direction of the reinforcing material using the second optical fiber included in the reinforcing material, and when the measurement values obtained in the second measurement process exceed the predetermined range, the first measurement process may be performed.

By performing the first measurement process and the second measurement process in combination and performing the first measurement process when abnormality is found in the measurement value obtained in the second measurement process, it is possible to further accurately measure and detect the conditions of the reinforcing materials, abnormality of the slope, and the like, while reducing the labor required for the measurement.
(14) A production method of measurement apparatus for reinforcing material conditions according to yet another aspect of the present disclosure includes: arranging an optical fiber with a protective material along a surface of a slope on which a plurality of reinforcing materials are secured, and to pass through a region where the plurality of reinforcing materials are arranged, wherein the optical fiber with the protective material includes a linear protective material and the first optical fiber, at least a portion of the first optical fiber is arranged along the longitudinal direction of the linear protective material, and at least a portion of a surface of the first optical fiber is covered with the linear protective material.

The production method of the measurement apparatus for reinforcing material conditions according to yet another aspect of the present disclosure can arrange the optical fiber with the protective material along the surface of the slope on which the plurality of reinforcing materials are secured, and to pass through the region where the plurality of reinforcing materials are arranged. According to the measurement apparatus for reinforcing material conditions produced by this production method, by oscillating scattered light in the first optical fiber with the protective material, it is possible to measure the strain distributions along the longitudinal direction of the first optical fiber. Since the axial force and the tension force of the plurality of reinforcing materials are reflected in the measured strain distributions, the axial force and the tension force of the reinforcing materials can be readily measured simply by oscillating scattered light in the first optical fiber.

When the portion of the surface of the first optical fiber with the protective material is covered with the protective material, the protective material can protect the first optical fiber thereby preventing damage or the like of the first optical fiber.
(15) In the above (14), the production method of the measurement apparatus for reinforcing material conditions may further include a spraying process of spraying mortar or concrete to cover the optical fiber with a protective material.

By performing the spraying process, a concrete structure can be produced to cover the optical fiber with the protective material. Therefore, the first optical fiber and the slope are protected, and the shape stability of the slope is enhanced.

### Details of Embodiments of Present Disclosure

Specific examples of the measurement apparatus for reinforcing material conditions, the measurement method for reinforcing material conditions, and the production method of the measurement apparatus for reinforcing material conditions according to the embodiment of the disclosure (hereinafter referred to as “the present embodiment”) will be described below with reference to the drawings. The present disclosure is not limited to these examples and is defined by the claims. It is intended to include all modifications within the meaning and scope of equivalents of the claims.

In the present specification, “first”, “second”, or the like is added to the names of members for description. For example, a first optical fiber with a protective material and a second optical fiber with a protective material are referred to. The “first” and “second” added to the optical fibers with the protective material are used only to identify the respective members and to prevent confusion in the description, and do not represent an arrangement or priority. When there is no possibility of confusion or when the members are collectively referred to, the first optical fiber with the protective material and the second optical fiber with the protective material can be referred to as an optical fiber with a protective material.

### [1] Measurement Apparatus for Reinforcing Material Conditions

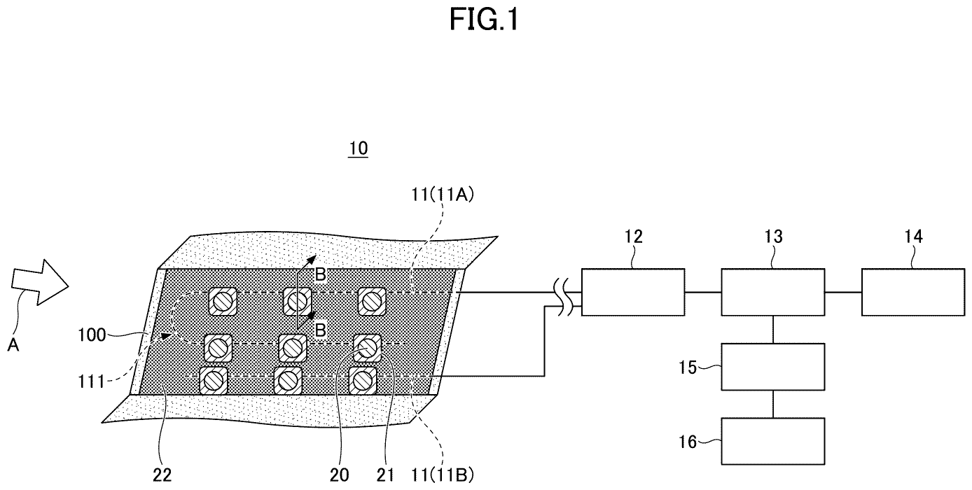

A configuration example of the measurement apparatus for reinforcing material conditions (hereinafter also referred to as a “measurement apparatus”) of the present embodiment will be described with reference to FIGS. 1, 2, 3A, 3B, 3C, and 4.

FIG. 1 is a perspective diagram of the measurement apparatus for reinforcing material conditions according to the present embodiment, with the measurement apparatus for reinforcing material conditions being arranged on a slope.

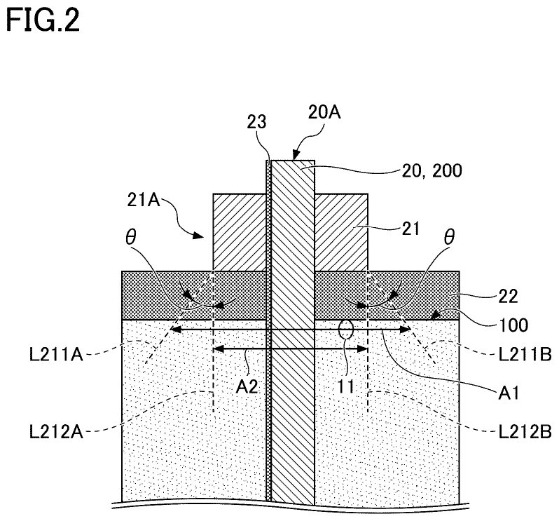

FIG. 2 is a schematic cross-sectional diagram taken along the line B-B in FIG. 1.

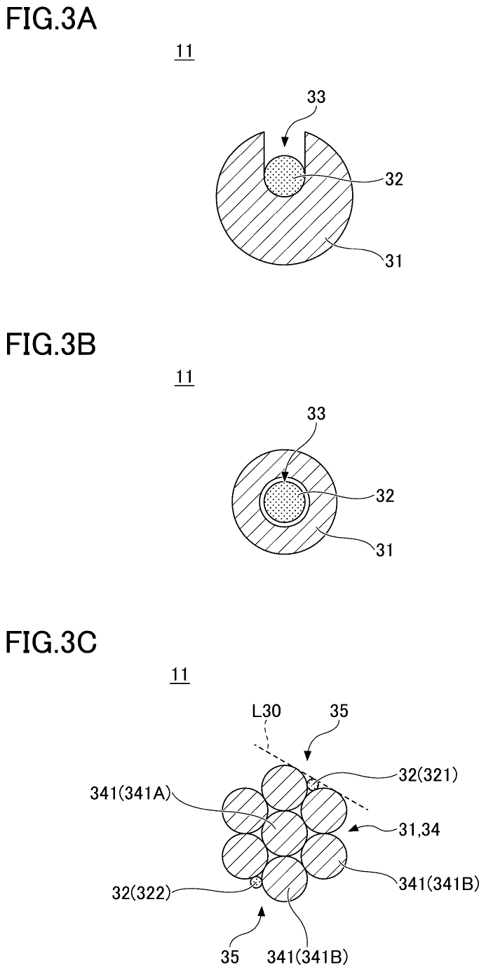

FIGS. 3A, 3B, and 3C are schematic cross-sectional diagrams of the optical fiber with the protective material in a plane orthogonal to the longitudinal direction of the optical fiber with the protective material.

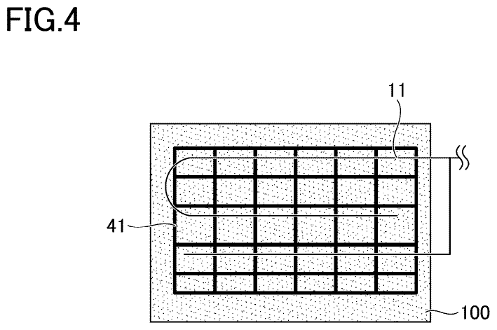

FIG. 4 is an explanatory diagram of a fixing member.

As illustrated in FIGS. 1 and 2, a measurement apparatus 10 of the present embodiment may include an optical fiber with a protective material 11 arranged along the surface of a slope 100.

A plurality of reinforcing materials 20 are secured into the slope 100 to intersect with the slope 100, and the optical fiber with the protective material 11 may be arranged to pass through a region where the plurality of reinforcing materials 20 are arranged.

For example, as illustrated in FIG. 3A, the optical fiber with the protective material 11 may include a protective material 31 and a first optical fiber 32. The first optical fiber 32 is configured to measure one or more selected data of the axial force and the tension force of the reinforcing materials 20.

The measurement apparatus 10 of the present embodiment is arranged such that the optical fiber with the protective material arranged along the surface of the slope is arranged to pass through the region where the plurality of reinforcing materials are arranged. By oscillating scattered light in the first optical fibers included in the optical fibers with the protective material, it is possible to measure strain distributions along the longitudinal directions of the first optical fibers. Since the axial force and the tension force of the plurality of reinforcing materials are reflected in the measured strain distributions, the axial force and the tension force of the reinforcing materials can be readily measured simply by oscillating scattered light in the first optical fibers.

In the present specification, the term “slope” means a slanting plane, and includes, for example, an artificial slope formed by cutting or embankment.

### (1) Optical Fiber With Protective Material

### (1-1) Arrangement of Optical Fiber With Protective Material on Slope

No particular limitation is imposed on the arrangement of the optical fiber with the protective material 11 on the slope 100. For example, as illustrated in FIG. 1, the optical fiber with the protective material 11 can be arranged along the surface of the slope 100 and to pass through the region where the plurality of reinforcing materials 20 are arranged.

The optical fiber with the protective material 11 can be arranged between a concrete structure 22 and the slope 100, and may be arranged to pass through the natural ground (the uppermost surface of a soil layer), i.e., the surface of the slope 100.

The measurement apparatus 10 of the present embodiment is configured to measure the axial force and the tension force of the reinforcing materials 20. Thus, the optical fibers with the protective material 11 may be arranged to pass through a region that is greatly influenced by the axial force and the tension force of the reinforcing materials.

FIG. 2 is a cross-sectional diagram taken along the line B-B in FIG. 1, i.e., a cross section of the reinforcing material 20. As illustrated in FIG. 2, a bearing plate 21 is arranged at an end 20A of the plurality of reinforcing materials 20. Thus, the concrete structure 22 and the bearing plate 21 are arranged over the surface of the slope 100.

The bearing plate 21 includes a fixture (not shown) configured to fix the end 20A of the reinforcing material 20. The bearing plate 21 is configured to apply pressure to compress the concrete structure 22 and the slope 100 by receiving the axial force and the tension force of the reinforcing material 20.

The optical fiber with the protective material 11 may be arranged to pass through the region receiving the pressure from the bearing plate 21. Specifically, the optical fiber with the protective material 11 may be arranged in a region A1. The region A1 is a region between a straight line L211A and a straight line L211B in a cross section passing through the center axis of the reinforcing material 20 as illustrated in FIG. 2. The straight line L211A has an angle θ of 45 degrees with respect to a vertical line L212A passing through the end 21A of the bearing plate 21, and the straight line L211B has an angle θ of 45 degrees with respect to a vertical line L212B passing through the end 21A of the bearing plate 21.

The optical fiber with the protective material 11 may be arranged in a region A2. The region A2 is a region between the vertical line L212A and the vertical line L212B, each passing through the end 21A of the bearing plate 21 in the cross section passing through the center axis of the reinforcing material 20 as illustrated in FIG. 2. That is, the optical fiber with the protective material 11 may be arranged to pass through a region between the slope 100 and the bearing plate 21 of the plurality of reinforcing materials 20.

By arranging the optical fiber with the protective material 11 to pass through the region between the bearing plate 21 and the slope 100, the first optical fiber 32 included in the optical fiber with the protective material 11 can strongly receive the axial force and the tension force of the reinforcing material 20 through the bearing plate 21. Therefore, the measurement apparatus of the present embodiment can measure the axial force and the tension force of the reinforcing material 20 with especially high accuracy.

The optical fiber with the protective material 11 may also include a folded portion 111 on the slope 100.

When the optical fiber with the protective material includes the folded portion 111, the single optical fiber with the protective material 11 can be arranged to pass through a region where a large number of the reinforcing materials 20 are arranged. This can increase the number of the reinforcing materials 20 whose axial force and tension force can be measured.

The measurement apparatus 10 of the present embodiment may also include a plurality of optical fibers with a protective material, such as a first optical fiber with a protective material 11A and a second optical fiber with a protective material 11B as illustrated in FIG. 1.

When the measurement apparatus 10 of the present embodiment includes a plurality of the optical fibers with the protective material 11, it is possible to measure one or more selected data of the axial force and the tension force of a large number of the reinforcing materials 20.

### (1-2) Protective Material

FIGS. 3A, 3B, and 3C are schematic cross-sectional diagrams of the optical fiber with the protective material 11 in a plane orthogonal to the longitudinal direction of the optical fiber with the protective material 11.

For example, as illustrated in FIG. 3A, the optical fiber with the protective material 11 may include the linear protective material 31 and the first optical fiber 32. At least a portion of the first optical fiber 32 included in the optical fiber with the protective material 11 may be arranged along the longitudinal direction of the protective material 31, and a portion of the surface of the first optical fiber 32 may be covered with the protective material 31.

When the portion of the surface of the first optical fiber 32 included in the optical fiber with the protective material 11 may be covered with the protective material 31, the protective material 31 can protect the first optical fiber 32 thereby preventing damage or the like of the first optical fiber 32.

Thus, the protective material 31 may include a groove or cavity to be an optical fiber housing 33 configured to receive the first optical fiber 32.

As illustrated in FIG. 3A, the protective material 31 may include a groove to be an optical fiber housing 33 along the longitudinal direction of the protective material 31, and may house the first optical fiber 32 in the groove.

Also, as illustrated in FIG. 3B, the protective material 31 may include, as the optical fiber housing 33, a tubular cavity along the longitudinal direction of the protective material 31. In FIG. 3B, the first optical fiber 32 is arranged in the cavity serving as the optical fiber housing 33 for the protective material 31, and thus the first optical fiber 32 is completely covered with the protective material 31.

As illustrated in FIG. 3C, the protective material 31 may include a stranded wire 34 of filaments 341, and the first optical fiber 32 may be arranged in stranded grooves 35 of the stranded wire 34.

When the protective material 31 includes the stranded wire 34, it is possible to readily bend the protective material 31. Therefore, the optical fiber with the protective material 11 can be readily deformed in accordance with the arrangement of the plurality of reinforcing materials 20, and the optical fiber with the protective material 11 can be readily arranged in the region where the plurality of reinforcing materials 20 are arranged.

When the protective material 31 includes the stranded wire 34, no particular limitation is imposed on the material of the filaments 341, and the filaments 341 may be resin filaments or metal filaments. From the viewpoint of enhancing the toughness of the protective material 31, the filaments 341 may be metal filaments. Therefore, the protective material 31 may include the stranded wire 34 of the metal filaments 341, and the first optical fiber 32 may be arranged in the stranded grooves 35 of the stranded wire 34.

Even if the filaments 341 are metal filaments, i.e., the protective material 31 is a metal wire, when the protective material 31 includes the stranded wire 34, it is possible to readily bend the protective material 31. Therefore, the optical fiber with the protective material 11 can be readily deformed in accordance with the arrangement of the plurality of reinforcing materials 20, and the optical fiber with the protective material 11 can be readily arranged in the region where the plurality of reinforcing materials 20 are arranged.

By arranging the first optical fiber 32 in the stranded grooves 35 of the stranded wire 34 of the filaments 341, it is possible to protect the first optical fiber thereby preventing damage or the like of the first optical fiber 32. By arranging the first optical fiber 32 in the stranded grooves 35 of the stranded wire 34 of the metal filaments 341, it is possible to effectively protect the first optical fiber thereby preventing damage or the like of the first optical fiber 32.

As illustrated in FIG. 3C, the first optical fiber 32 may be arranged to be entirely housed in a region enclosed by: a tangent line L30 of two of the filaments 341 next to each other along the outer periphery of the stranded wire 34; and two of the filaments 341 next to each other along the outer periphery of the stranded wire 34. The tangent line L30 is a tangent line in contact with the outer periphery of the stranded wire 34. Also, the two filaments 341 forming the above region are the two filaments 341 in contact with the tangent line L30.

By arranging the first optical fiber 32 in the region enclosed by the tangent line L30 and the two filaments 341 next to each other along the outer periphery of the stranded wire 34, the first optical fiber 32 is protected by the two filaments 341, i.e., the first optical fiber 32 is not directly contacted by any other member. Therefore, an external force is not directly applied to the first optical fiber 32, thereby effectively preventing damage or the like of the first optical fiber 32.

As illustrated in FIGS. 3A and 3C, by exposing a portion of the first optical fiber 32 while covering another portion of the first optical fiber 32 with the protective material 31, it is possible to readily take out the first optical fiber 32 at a desired place on the protective material 31, and to connect the taken-out first optical fiber 32 to the scattered light measurement device. In addition, for example, even if the first optical fiber 32 is cut, reconnecting work or the like is readily performed.

No particular limitation is imposed on the number and structure of the filaments 341 included in the stranded wire 34. For example, the number of the filaments 341 included in the stranded wire 34 may be seven or nineteen. When the number of the filaments 341 included in the stranded wire 34 is seven, the structure of the stranded wire 34 can be a single-stranded structure in which six outer filaments 341B are helically stranded around the single center filament 341A, as illustrated in FIG. 3C. In this case, the outer filaments 341B are positioned at the outermost periphery of the stranded wire 34. Although FIG. 3C is an example in which filaments having the same filament diameter are used as the center filament 341A and the outer filaments 341B, the present invention is not limited to this configuration. For example, the filament diameter of the center filament 341A may be different from the filament diameters of the outer filaments 341B.

No particular limitation is imposed on the material of the protective material 31. For protecting the first optical fiber 32, the material of the protective material 31 may be a metal. That is, the protective material 31 may be a metal protective material, e.g., a metal wire. By using a metal protective material, e.g., a metal wire as the protective material 31, it is possible to enhance the toughness of the protective material 31, such as a metal wire or the like, and effectively prevent damage or the like of the protective material 31 and the first optical fiber 32 arranged over the protective material 31.

No particular limitation is imposed on the metal used for the metal wire 31. For example, it is possible to use one or more selected from the group consisting of aluminum, an aluminum alloy, steel, and the like.

The first optical fiber 32 may be fixed to the protective material 31 using a resin or the like. In this case, the resin for use may be an ultraviolet-curable resin.

For protecting the protective material 31 and the first optical fiber 32, at least a portion of the surface of the protective material 31 or the first optical fiber 32 may be coated by an anticorrosive coating.

No particular limitation is imposed on the material of the anticorrosive coating, and, for example, a resin having excellent corrosion resistance can be used. The resin used for the anticorrosive coating is, for example, one or more selected from the group consisting of an epoxy resin, a polyethylene resin, and the like. The anticorrosive coating may include a plurality of layers, and the material may be different or the same for each layer.

### (1-3) First Optical Fiber

The first optical fiber 32 may be, for example, an optical fiber including a core and a clad. The material of the core and the clad is, for example, plastics or quartz glass. The first optical fiber may be one or more selected from the group consisting of an optical fiber filament including a primary coating on the outer periphery of the clad, an optical fiber core wire further including a secondary coating on the optical fiber filament, and an optical fiber code further including a reinforcing material on the outer periphery of the secondary coating and a sheath covering the outer periphery of the reinforcing material.

The material of the primary coating is, for example, an ultraviolet-curable resin. The material of the secondary coating is, for example, a flame-retardant polyester elastomer. The material of the reinforcing material is, for example, a glass fiber, a carbon fiber, or an aramid fiber. The material of the sheath is, for example: flame-retardant polyolefin, such as flame-retardant polyethylene or the like; flame-retardant cross-linked polyolefin, such as flame-retardant cross-linked polyethylene or the like; or heat-resistant vinyl.

No particular limitation is imposed on the type of the optical fiber used as the first optical fiber, and the type of the optical fiber may be selected in accordance with the type of measurement parameters, such as strain and the like, the measurement method, the type of scattered light used for the measurement, and the like. The first optical fiber for use may be, for example, one or more optical fibers selected from a single-mode optical fiber, a multimode optical fiber, and a polarization maintaining optical fiber.

No particular limitation is imposed on the outer diameter of the first optical fiber 32, and the outer diameter of the first optical fiber 32 may be, for example, 1.5 millimeters (mm) or less, or 1.0 mm or less.

When the outer diameter of the first optical fiber 32 is set to be 1.5 mm or less, the first optical fiber 32 can be readily arranged. Also, when the first optical fiber 32 is to be arranged in the optical fiber housing 33 for the protective material 31, there is no need to excessively increase the size of the optical fiber housing 33.

No particular limitation is imposed on the lower limit of the outer diameter of the first optical fiber 32, and the outer diameter of the first optical fiber 32 may be 0.235 mm or more, or 0.8 mm or more. When the outer diameter of the first optical fiber 32 is set to be 0.235 mm or more, the durability of the first optical fiber 32 can be enhanced. When the first optical fiber 32 is arranged and fixed on a measurement surface, such as a slope or the like, heat or an external force may be applied to the first optical fiber. However, by setting the outer diameter of the first optical fiber 32 to be 0.235 mm or more, it is possible to prevent damage of the first optical fiber 32 at the time of arrangement or the like of the first optical fiber 32.

No particular limitation is imposed on the number of the first optical fibers 32 included in the optical fiber with the protective material 11. For example, as in the optical fiber with the protective material 11 as illustrated in FIGS. 3A and 3B, the optical fiber with the protective material 11 may include the single first optical fiber 32.

However, since the first optical fiber 32 may break when or after the optical fiber with the protective material 11 is arranged, the optical fiber with the protective material 11 may include a plurality of optical fibers.

Specifically, for example, as in the optical fiber with the protective material 11 illustrated in FIG. 3C, the optical fiber with the protective material 11 may include two or more first optical fibers 32.

The optical fiber with the protective material 11 illustrated in FIG. 3C includes two first optical fibers, i.e., a first optical fiber 321 and a first optical fiber 322, arranged in the stranded grooves 35 of the stranded wire 34, which is the protective material 31. No particular limitation is imposed on the arrangement of the first optical fiber 321 and the first optical fiber 322 in the stranded wire 34, and the first optical fiber 321 and the first optical fiber 322 may be arranged in the same stranded groove 35 or in different stranded grooves 35. For example, as illustrated in FIG. 3C, the first optical fiber 321 and the first optical fiber 322 may be arranged in the stranded grooves 35 located at opposing positions in a cross section perpendicular to the longitudinal direction of the stranded wire 34.

### (2) Fixing Member

The measurement apparatus 10 of the present embodiment may include the fixing member configured to fix at least a portion of the optical fiber with the protective material 11 to the slope 100.

When at least the portion of the optical fiber with the protective material 11 is fixed by the fixing member, it is possible to prevent displacement of the optical fiber with the protective material 11 after arrangement. Therefore, after arrangement of the optical fiber with the protective material 11, it is possible to increase positional accuracy when measuring strain or the like.

FIG. 4 is a configuration example in which the measurement apparatus 10 includes the fixing member 41 as the slope 100 is viewed from a position above the slope 100 in the vertical direction, i.e., as viewed along a block arrow A in FIG. 1. In FIG. 4, illustration of the concrete structure 22 is omitted.

The fixing member 41 can be arranged, for example, on the surface of the slope 100. For example, as illustrated in FIG. 4, at least a portion of the fixing member 41 may have a grid shape.

The grid shape is not limited to a rectangular grid shape as illustrated in FIG. 4, and may be a rhombic shape, a polygonal shape, or the like.

The fixing member 41 having a grid shape can increase the number of contact sites between the fixing member 41 and the optical fiber with the protective material 11, and thus the optical fiber with the protective material 11 can be readily fixed to the fixing member 41.

The slope 100 and the optical fiber with the protective material 11 may be sprayed with mortar or concrete, and thus may be covered with the concrete structure 22. The fixing member 41 having a grid shape can support the concrete structure 22.

No particular limitation is imposed on the material of the fixing member 41, and, for example, a metal may be used. Examples of the metal include steel, stainless steel, aluminum, aluminum alloys, and the like.

### (3) Scattered Light Measurement Device

The measurement apparatus 10 of the present embodiment may further include a measurement function 12 including a scattered light measurement device connected to the first optical fiber 32.

When the measurement apparatus 10 includes the measurement function 12 including the scattered light measurement device connected to the first optical fiber 32, it is possible to readily measure strain and the like along the longitudinal direction of the first optical fiber 32. Also, it is possible to determine one or more selected data of the axial force and the tension force of the plurality of reinforcing materials 20, for example, based on the strain distributions along the longitudinal direction of the first optical fiber 32. The scattered light measurement device does not need to be always connected to the first optical fiber 32, and may be removable such that the scattered light measurement device is connected only at the time of measurement.

When the measurement apparatus 10 includes a plurality of first optical fibers 32, the scattered light measurement device may include a switching device configured to switch an optical fiber to receive oscillation and irradiation with the scattered light in order to switch the first optical fiber 32 used for measurement.

The measurement function 12 may be configured to perform a plurality of times of measurements at predetermined intervals. No particular limitation is imposed on the predetermined intervals. For example, the measurement may be performed for each of the predetermined fixed times, or the measurement may be performed at specific intervals, such as in the morning, at night, and the like, within a specific period, such as a day, a month, a year, or the like.

A measurement method of the strain or the like using the scattered light measurement device will be described in the following section of the measurement method.

### (4) Calculator

The measurement apparatus 10 of the present embodiment may further include a calculator 13.

When the measurement function 12 performs a plurality of times of measurements, the calculator 13 may calculate temporal changes of one or more selected data of the axial force and the tension force of the plurality of reinforcing materials 20, for example, based on changes in the strain distributions measured by the measurement function 12 along the longitudinal direction of the first optical fiber 32.

When the measurement function 12 performs a plurality of times of measurements at predetermined intervals, and the calculator 13 calculates the temporal changes of one or more selected data of the axial force and the tension force of the reinforcing materials applied to the plurality of reinforcing materials 20 based on the changes in the strain distributions, it is possible to observe the change in the axial force and the like of the reinforcing materials.

The calculator 13 may include a CPU, i.e., an arithmetic processing unit configured to perform necessary calculations, RAM and ROM, i.e., main storage devices, an auxiliary storage device, an input/output interface, and a display device, i.e., an output device. The CPU, main storage device, auxiliary storage device, input/output interface, and output device included in the calculator 13 can be connected to each other via a bus. All the above components included in the calculator 13 do not need to be included in a single housing. For example, the auxiliary storage device and the display device may be provided outside. The auxiliary storage device is a storage device, such as an SSD, an HDD, or the like.

CPU stands for a central processing unit, RAM stands for a random access memory, and ROM stands for a read only memory. SSD stands for a solid state drive, and HDD stands for a hard disk drive.

The input/output interface is, for example, a wired or wireless interface configured to exchange measurement data. Examples of the input/output interface include an interface configured to exchange measurement data with the scattered light measurement device included in the measurement function 12, and an interface configured to control a function 14 configured to issue an alarm. Also, for example, in the case of receiving measurement values calculated at a remote location, the input/output interface may include, for example, a communication port configured to transmit the measurement values to the remote location via a network.

Further examples of the input/output interface include, for example, user interfaces, such as a touch panel, a keyboard, and an operation button, configured to select data to be calculated by the calculator 13.

The main storage device and the auxiliary storage device may previously store a program for calculating strain and the like from the measurement data measured by the measurement function 12. Also, the main storage device and the auxiliary storage device may previously store data, such as, for example, the strain calculated by the calculator 13, and the previously stored data may be used to calculate the temporal changes of strain and the like.

The calculator 13 may be formed, for example, by a personal computer (PC). Therefore, each component included in the calculator 13 may be implemented by software and hardware in cooperation by the CPU executing the previously stored program in an information processing device, such as a personal computer or the like.

### (5) Function Configured to Issue Alarm

The measurement apparatus 10 of the present embodiment may further include the function 14. The function 14 is configured to issue an alarm when the temporal changes in one or more selected from the axial force or tension force of the plurality of reinforcing materials 20 calculated by the calculator 13 exceed the predetermined range.

When the measurement apparatus 10 of the present embodiment includes the function 14, it is possible to rapidly notify an operator, a manager, or the like of a problem with the conditions of the axial force and the tension force of the reinforcing materials 20.

The function 14 may include, for example, a display, a lamp, a buzzer, or the like for issuing an alarm such that the operator or the manager can recognize a change in the conditions of the axial force and the like of the reinforcing materials 20. The function 14 may be arranged, for example, in the calculator 13, and may serve as a display or the like of the calculator 13.

### (6) Function Configured to Locate Position

As illustrated in FIG. 1, the measurement apparatus 10 of the present embodiment may also include the concrete structure 22 arranged to cover the slope 100 and the optical fiber with the protective material 11.

The concrete structure 22 can be produced by spraying mortar or concrete onto the slope 100 or the optical fiber with the protective material 11, and curing the mortar or concrete.

When the optical fiber with the protective material 11 is covered with the concrete structure 22 or the like, the optical fiber with the protective material 11 cannot be seen from the outside because of the presence of the concrete structure 22.

Thus, the measurement apparatus 10 of the present embodiment may include a function 15 configured to locate the position of the reinforcing material 20 on the first optical fiber 32 based on the strain distributions measured by the measurement function 12 along the longitudinal direction of the first optical fiber 32.

In the strain distribution measured by the first optical fiber 32 included in the optical fiber with the protective material 11, the strain increases at a position of the region where the reinforcing materials 20 are arranged. Thus, the strain distribution enables the position of each reinforcing material 20 to be located. The function 15 locates the position of each reinforcing material 20 based on the strain distributions along the longitudinal direction of the first optical fiber 32, thereby accurately specifying the axial force and the tension force of each reinforcing material 20.

The measurement apparatus 10 of the present embodiment may include a recorder 16 configured to record position information of the optical fiber with the protective material 11, such as, for example, the arrangement of the optical fiber with the protective material 11 on the slope 100, and the order of the reinforcing materials 20 on the optical fiber with the protective material 11.

The function 15 may locate the position of the reinforcing materials 20 on the first optical fiber 32 based on the strain distributions along the longitudinal direction of the first optical fiber 32 in consideration of the position information of the first optical fiber 32 included in the recorder 16.

When the function 15 locates the position of the reinforcing materials 20 on the first optical fiber 32 based on the strain distributions along the longitudinal direction of the first optical fiber 32 in consideration of the position information of the optical fiber with the protective material 11 included in the recorder 16, it is possible to especially accurately locate the position of the reinforcing materials 20.

The function 15 and the recorder 16 may be provided separately, or may be provided as a single device. Also, some or all of the calculator 13, the function 15, and the recorder 16 may be provided as a single device. Therefore, for example, the recorder 16 may be formed by the auxiliary storage device or the like included in the calculator 13, and the function 15 may be formed by the CPU, main storage device, auxiliary storage device, input/output interface, output device, and the like included in the calculator 13.

Like in the calculator 13, the function 15 and the recorder 16 may include a CPU, i.e., an arithmetic processing unit configured to perform necessary calculations, RAM and ROM, i.e., main storage devices, an auxiliary storage device, an input/output interface, and a display device, i.e., an output device. Since the CPU and the like have been described for the calculator 13, descriptions thereof are omitted.

The function 15 and the recorder 16 may be formed, for example, by a personal computer (PC). Therefore, each component included in the function 15 and the recorder 16 may be implemented by software and hardware in cooperation by the CPU executing a previously stored program in an information processing device, such as a personal computer or the like.

### (7) Reinforcing Material

A plurality of reinforcing materials 20 can be arranged to intersect with the slope 100.

The reinforcing materials 20 can apply a compressive force to the natural ground including the slope 100. By arranging the plurality of reinforcing materials 20 on the slope 100, it is possible to maintain the shape of the slope 100 thereby preventing a landslide and the like.

The reinforcing materials 20 for use may be a ground anchor or a rock bolt.

At least a portion of the plurality of reinforcing materials 20 can be a reinforcing material 200 including a second optical fiber 23 arranged along the longitudinal direction of the reinforcing material 200. Also, all the reinforcing materials 20 can include the second optical fiber 23 arranged along the longitudinal direction of the reinforcing materials 20.

By using the first optical fiber 32 of the optical fiber with the protective material 11 included in the measurement apparatus 10 of the present embodiment, it is possible to measure one or more selected data of the axial force and the tension force of the plurality of reinforcing materials 20. Since the measurement apparatus 10 includes the second optical fiber 23 arranged along the longitudinal direction of the reinforcing materials 20, for example, when abnormality is found in the axial force or the tension force of the reinforcing materials 20 measured using the first optical fiber 32, it is possible to measure the strain distribution along the longitudinal direction of the reinforcing material 20 in which the abnormality was found. Therefore, when the measurement apparatus 10 of the present embodiment includes the second optical fiber 23 arranged along the longitudinal direction of the reinforcing materials 20, it is possible to measure the axial force and the like of the reinforcing materials 20 with higher accuracy.

The order of the measurements is not limited to the above embodiment. For example, the second optical fiber 23 may be used to measure one or more selected data of the axial force and the tension force along the longitudinal direction of the reinforcing material 200. When abnormality is found in the axial force or the tension force of the reinforcing material 20 measured using the second optical fiber 23, the first optical fiber 32 may be used to measure one or more selected data of the axial force and the tension force of the plurality of reinforcing materials 20.

By measuring the axial force or the tension force of the reinforcing materials 20 using the first optical fiber 32 and the second optical fiber 23 in combination, it is possible to measure and detect the conditions of the reinforcing materials 20, abnormality of the slope, and the like with higher accuracy, while reducing the labor required for the measurement.

The strain distribution along the longitudinal direction of the second optical fiber 23 included in the reinforcing material 20 may be measured by the measurement function 12 including the scattered light measurement device, or may be measured by a separately provided reinforcing material measurement function including a scattered light measurement device.

The second optical fiber 23 included in the reinforcing material 20 may be an optical fiber that is the same as the first optical fiber 32 described for the optical fiber with the protective material 11, and thus, descriptions thereof are omitted.

For example, a portion of the surface of the second optical fiber 23 may be covered with the reinforcing material 20, and protected by the reinforcing material 20. Specifically, for example, when the reinforcing material 20 is a PC steel stranded wire, the second optical fiber 23 may be arranged between the stranded wires. PC of the PC steel stranded wire stands for prestressed concrete.

### [2] Measurement Method for Reinforcing Material Conditions

A measurement method for reinforcing material conditions (hereinafter also referred to as a “measurement method”) of the present embodiment will be described. The measurement method of the present embodiment can be performed, for example, using the measurement apparatus according to the aspect of the present disclosure. Thus, some of the matters described for the measurement apparatus are omitted.

### (1) First Measurement Process

The measurement method of the present embodiment can include a first measurement process.

In the first measurement process, scattered light can be oscillated from the measurement function 12 including the scattered light measurement device in the first optical fiber 32 included in the optical fiber with the protective material 11, thereby measuring one or more selected data of the axial force and the tension force of the plurality of reinforcing materials 20.

The optical fiber with the protective material 11 may be arranged along the surface of the slope 100 on which the plurality of reinforcing materials 20 are secured, and to pass through a region where the plurality of reinforcing materials 20 are arranged.

The optical fiber with the protective material 11 may include, for example, the linear protective material 31 and the first optical fiber 32. At least a portion of the first optical fiber 32 may be arranged along the longitudinal direction of the protective material 31. A portion of the surface of the first optical fiber 32 may be covered with the protective material 31.

In the first measurement process of the measurement method of the present embodiment, scattered light can be oscillated in the first optical fiber 32 included in the optical fiber with the protective material 11 arranged along the surface of the slope 100 and to pass through the region where the plurality of reinforcing materials 20 are arranged. By oscillating the scattered light in the first optical fiber 32, it is possible to measure the strain distributions along the longitudinal direction of the first optical fiber 32. Since the axial force and the tension force of the plurality of reinforcing materials 20 are reflected in the measured strain distributions, the axial force and the tension force of the reinforcing materials 20 can be readily measured simply by oscillating scattered light in the first optical fiber 32.

When a portion of the surface of the first optical fiber 32 included in the optical fiber with the protective material 11 is covered with the protective material 31, the protective material 31 can protect the first optical fiber 32 thereby preventing damage or the like of the first optical fiber 32.

A measurement method of a value of strain or the like using the first optical fiber 32 in the first measurement process will be described.

### Measurement of Strain

In the measurement of strain in the first measurement process, the first measurement process can measure strain at a desired position along the longitudinal direction of the first optical fiber, or a strain distribution along the longitudinal direction of the first optical fiber. Also, it is possible to obtain one or more selected data of the axial force and the tension force of the plurality of reinforcing materials 20, for example, based on the strain distributions along the longitudinal direction of the first optical fiber 32.

No particular limitation is imposed on the scattered light used for the measurement of strain, and the scattered light used for the measurement of strain is, for example, one or more selected from the group consisting of Brillouin scattered light, Rayleigh scattered light, and Raman scattered light.

No particular limitation is imposed on the measurement method of strain, and the measurement method of strain is, for example, one or more selected from the group consisting of BOCDA (Brillouin Optical Correlation Domain Analysis), BOTDR (Brillouin Optical Time Domain Reflectometry), FBG (Fiber Bragg Grating), BOTDA (Brillouin Optical Time Domain Analysis), BOCDR (Brillouin Optical Correlation Domain Reflectometry), and the like.

The number of the first optical fibers used for measuring the strain in the first measurement process may be selected in accordance with the measurement method or the like. For example, when the measurement method is BOCDA or BOTDA, the number of the first optical fibers may be an even number of two or more, and when the measurement method is BOTDR, FBG, or BOCDR, the number of the first optical fibers may be one or more.

### Measurement of Temperature

A temperature can also be measured in the first measurement process. When the temperature is measured in the first measurement process, the first measurement process can measure a temperature at a desired position along the longitudinal direction of the first optical fiber, or a temperature distribution along the longitudinal direction of the first optical fiber.

No particular limitation is imposed on the scattered light used for the measurement of temperature, and the scattered light used for the measurement of temperature is, for example, one or more selected from the group consisting of Brillouin scattered light, Rayleigh scattered light, and Raman scattered light.

No particular limitation is imposed on the measurement method of temperature, and the measurement method of temperature is, for example, one or more selected from the group consisting of BOCDA, BOTDR, FBG, BOTDA, BOCDR, ROTDR (Raman Optical Time Domain Reflectometer), and the like.

The number of the first optical fibers used for measuring the temperature in the first measurement process may be selected in accordance with the measurement method or the like. For example, when the measurement method is BOCDA or BOTDA, the number of the first optical fibers may be an even number of two or more, and when the measurement method is BOTDR, FBG, BOCDR, or ROTDR, the number of the first optical fibers may be one or more.

### (2) Determination Process

The measurement method of the present embodiment may include a determination process of determining the state of the axial force or the tension force of the plurality of reinforcing materials 20 in accordance with the measurement value obtained in the first measurement process.

For example, the measurement method of the present embodiment may also repeatedly perform the first measurement process at a predetermined timing. The determination process can obtain the temporal changes of one or more selected data of the axial force and the tension force of the reinforcing materials measured in the first measurement process, and, when the change is equal to or greater than a predetermined value, can determine abnormality in the axial force and the like. Also, when the change is less than the predetermined value, the determination process can determine that no abnormality is in the axial force and the like, i.e., the axial force and the like are normal.

The measurement method of the present embodiment may further include an optional process.

### (3) Correction Process

The measurement method of the present embodiment may further include a correction process.

In the correction process, the strain measured in the first measurement process can be corrected using the temperature measured in the first measurement process.

In the correction process, for example, the strain after correction can be calculated by the following equation (1).

$$( Strain after correction ( \% ) ) = ( Measured strain ( \% ) ) - ( Measured temperature ( ° C . ) ) \times ( Temperature coefficient ( \% / ° C . ) ) \qquad ( 1 )$$

Instead of the “Measured temperature” in equation (1), a temperature change from a reference temperature can be used.

The temperature coefficient can be previously calculated from a relationship between a known temperature and a known amount of strain, for example, by using an optical fiber that is the same as that used for the measurement.

By performing the correction process, it is possible to correct the measured strain or the strain distribution in accordance with the temperature, thereby measuring the strain with especially high accuracy.

### (4) Second Measurement Process

At least a portion of the plurality of reinforcing materials may be the reinforcing material 200 including the second optical fiber arranged along the longitudinal direction of the reinforcing material.

In this case, the measurement method of the present embodiment may further include a second measurement process. No particular limitation is imposed on the conditions for performing the second measurement process. For example, the second measurement process may be performed when the measurement value obtained in the first measurement process is outside the predetermined range. The second measurement process may be performed when it is determined in the determination process that abnormality is found in the axial force and the like of the reinforcing material 20.

In the second measurement process, for example, one or more selected data of the axial force and the tension force along the longitudinal direction of the reinforcing material 200 may be measured using the second optical fiber 23 included in the reinforcing material 200. By measuring the axial force and the like along the longitudinal direction of the reinforcing material in the second measurement process, it is possible to especially accurately evaluate the axial force and the like of the reinforcing material 20.

When no abnormality is found in the axial force and the tension force of the reinforcing material 20 in the second measurement process, the measurement result in the first measurement process may be corrected. When abnormality is found in the axial force and the like of the reinforcing material 20 in the second measurement process, the reinforcing material 20 may be replaced, or the tension force or the like may be introduced again into the reinforcing material 20.

The order of the first measurement process and the second measurement process is not limited to the above-described embodiment.

For example, when the measurement value obtained in the second measurement process is outside the predetermined range, the first measurement process may be performed.

When no abnormality is found in the axial force and the tension force of the reinforcing material 20 in the first measurement process, the second measurement process may be performed again, or the measurement result in the second measurement process may be corrected. When abnormality is found in the axial force, the tension force, or the like of the measured reinforcing material 20 in the first measurement process, the reinforcing material 20 may be replaced, or the tension force or the like may be introduced again into the reinforcing material 20.

In the first measurement process, the strain or the like can be measured over a range of the surface of the slope 100 that is wider than that in the second measurement process. Therefore, information of the reinforcing materials 20 and the surroundings of the reinforcing materials 20 can be obtained, and abnormality or the like of the slope can also be detected.

Therefore, by performing the first measurement process and the second measurement process in combination, and performing the first measurement process when abnormality is found in the measurement value obtained in the second measurement process, it is possible to measure and detect the state of the reinforcing materials 20, abnormality of the slope, and the like with higher accuracy, while reducing the labor required for the measurement.

### (5) Concrete Structure Measurement Process

The measurement method of the present embodiment may include a concrete structure measurement process.

In the concrete structure measurement process, Rayleigh scattered light can be oscillated in the second optical fiber arranged along the longitudinal direction of the reinforcing material 20, thereby measuring a Poisson's ratio of the concrete structure 22 due to fluctuation in the tension force of the reinforcing material 20.

### [3] Production Method of Measurement Apparatus for Reinforcing Material Conditions

A production method of the measurement apparatus of the present embodiment will be described. The production method of the measurement apparatus of the present embodiment can produce the measurement apparatus according to the aspect of the present disclosure. Thus, some of the matters described for the measurement apparatus and the measurement method are omitted.

### (1) Optical Fiber Arrangement Process and Fixing Member Arrangement Process

The production method of the measurement apparatus of the present embodiment can include an arrangement process of arranging an optical fiber with a protective material.

In the arrangement process of the optical fiber with the protective material, the optical fiber with the protective material 11 can be arranged along the surface of the slope 100 on which the plurality of reinforcing materials 20 are secured, and to pass through a region where the plurality of reinforcing materials 20 are arranged.

The optical fiber with the protective material 11 used in the arrangement process of the optical fiber with the protective material may include the linear protective material 31 and the first optical fiber 32. At least a portion of the first optical fiber 32 may be arranged along the longitudinal direction of the protective material 31, and a portion of the surface of the first optical fiber 32 may be covered with the protective material 31.

The measurement apparatus for reinforcing material conditions produced by the production method of the measurement apparatus of the present embodiment can measure the strain distributions along the longitudinal direction of the first optical fiber 32 by oscillating scattered light in the first optical fiber 32 included in the optical fiber with the protective material 11. Since the axial force and the tension force of the plurality of reinforcing materials are reflected in the measured strain distributions, the axial force and the tension force of the reinforcing materials can be readily measured simply by oscillating scattered light in the first optical fiber 32.

When the portion of the surface of the first optical fiber 32 included in the optical fiber with the protective material 11 is covered with the protective material 31, the protective material 31 can protect the first optical fiber 32 thereby preventing damage or the like of the first optical fiber 32.

In the arrangement process of arranging the optical fiber with the protective material, for example, as illustrated in FIG. 1, the optical fiber with the protective material 11 may be arranged on the surface of the slope 100 to include the folded portion 111. Also, in the arrangement process of arranging the optical fiber with the protective material, a plurality of the optical fibers with the protective material 11 may be arranged along the surface of the slope 100.

In the arrangement process of arranging the optical fiber with the protective material, no particular limitation is imposed on the method of arranging and fixing the optical fiber with the protective material 11 to the slope 100. For example, the optical fiber with the protective material 11 may be fixed by the fixing member 41 that is previously arranged on the surface of the slope 100.

When the fixing member 41 is arranged on the surface of the slope 100, the production method of the measurement apparatus of the present embodiment may include a fixing member arrangement process of arranging the fixing member 41 along the surface of the slope 100. In the fixing member arrangement process, the fixing member 41 can be arranged along the surface of the slope 100, followed by fixing.

### (2) Recording Process of Recording Position of Optical Fiber With Protective Material

The production method of the measurement apparatus of the present embodiment may include a recording process of recording a position of an optical fiber with a protective material.

The recording process of recording the position of the optical fiber with the protective material can record the position of the optical fiber with the protective material on the slope 100. The position of the optical fiber with the protective material 11 recorded in the recording process of recording the position of the optical fiber with the protective material can be, for example, recorded and stored in the recorder 16 of the measurement apparatus according to the aspect of the present disclosure.

When the production method of the measurement apparatus of the present embodiment includes the recording process of recording the position of the optical fiber with the protective material, and position information of the optical fiber with the protective material 11 on the slope 100 is recorded, it is possible to especially accurately locate the position of the reinforcing material 20 on the first optical fiber 32. Therefore, by using the measurement results of the axial force and the like of the reinforcing material 20 obtained in the measurement process, it is possible to especially accurately evaluate the conditions of the reinforcing material 20, such as the axial force and the like.

### (3) Spraying Process

The production method of the measurement apparatus of the present embodiment may include a spraying process.

In the spraying process, mortar or concrete can be sprayed to cover the slope 100 and the optical fiber with the protective material 11. When the sprayed mortar or concrete hardens, the concrete structure 22 can be formed.

By performing the spraying process, it is possible to produce the concrete structure 22 to cover the optical fiber with the protective material 11. Therefore, the first optical fiber 32 and the slope 100 can be protected to enhance the shape stability of the slope 100.

According to the present disclosure, it is possible to provide measurement apparatus for reinforcing material conditions configured to readily measure the conditions of a plurality of reinforcing materials arranged on a slope.

What is claimed is:

1. Measurement apparatus for reinforcing material conditions, comprising:
an optical fiber with a protective material arranged on a surface of a slope on which a plurality of reinforcing materials are secured to intersect with the slope, and configured to pass through a region where the plurality of reinforcing materials are arranged, wherein
the optical fiber with the protective material includes a linear protective material and a first optical fiber,
at least a portion of the first optical fiber is arranged along the longitudinal direction of the linear protective material, and
at least a portion of a surface of the first optical fiber is covered with the linear protective material.

2. The measurement apparatus for reinforcing material conditions according to claim 1, wherein
the protective material includes a metal wire.

3. The measurement apparatus for reinforcing material conditions according to claim 2, wherein
the metal wire includes stranded individual wires, and
the first optical fiber is arranged in a groove between the stranded wires.

4. The measurement apparatus for reinforcing material conditions according to claim 1, wherein
the measurement apparatus for reinforcing material conditions includes a plurality of optical fibers with a protective material.

5. The measurement apparatus for reinforcing material conditions according to claim 1, wherein
a bearing plate is included at the end of the plurality of reinforcing materials, and
the optical fiber with the protective material is arranged to pass through a region between the slope and the bearing plate.

6. The measurement apparatus for reinforcing material conditions according to claim 1, wherein
at least a portion of the plurality of reinforcing materials is a reinforcing material including a second optical fiber arranged along the longitudinal direction of the reinforcing material.

7. The measurement apparatus for reinforcing material conditions according to claim 1, further comprising:
a measurement function including a scattered light measurement device connected to the first optical fiber.

8. The measurement apparatus for reinforcing material conditions according to claim 7, further comprising:
a function configured to locate a position of the plurality of reinforcing materials on the first optical fiber based on strain distributions measured by the measurement device along the longitudinal direction of the first optical fiber.

9. The measurement apparatus for reinforcing material conditions according to claim 7, wherein
the measurement device is configured to perform a plurality of times of measurements at predetermined intervals, and
the measurement apparatus for reinforcing material conditions further includes a calculator configured to determine temporal changes of one or more selected data of the axial force and the tension force of the plurality of reinforcing materials based on changes in strain distributions measured by the measurement device along the longitudinal direction of the first optical fiber.

10. The measurement apparatus for reinforcing material conditions according to claim 9, further comprising:
a function configured to issue an alarm when the temporal changes in one or more selected data of the axial force and the tension force of the plurality of reinforcing materials calculated by the calculator exceed the predetermined range.

11. A measurement method for reinforcing material conditions, comprising:
a first measurement process of oscillating scattered light from a measurement device using scattered light emitted into a first optical fiber with a protective material arranged on a surface of a slope on which a plurality of reinforcing materials are secured and to pass through a region where the plurality of reinforcing materials are arranged, thereby measuring one or more selected data of the axial force and the tension force of the plurality of reinforcing materials, wherein
the first optical fiber with the protective material includes a linear protective material,
at least a portion of the first optical fiber is arranged along the longitudinal direction of the linear protective material, and
at least a portion of the surface of the first optical fiber is covered with the linear protective material.

12. The measurement method for reinforcing material conditions according to claim 11, wherein
at least a portion of the plurality of reinforcing materials is a reinforcing material including a second optical fiber arranged along the longitudinal direction of the reinforcing material, and
the measurement method for reinforcing material conditions further includes, when measured values obtained in the first measurement process exceed the predetermined range, a second measurement process of one or more selected data of the axial force and the tension force along the longitudinal direction of the reinforcing material using the second optical fiber is available.

13. The measurement method for reinforcing material conditions according to claim 11, wherein
at least a portion of the plurality of reinforcing materials is a reinforcing material including a second optical fibers arranged along the longitudinal direction of the reinforcing material,
the measurement method for reinforcing material conditions further includes a second measurement process of one or more selected data of the axial force and the tension force along the longitudinal direction of the reinforcing material using the second optical fiber included in the reinforcing material, and
when the measurement values obtained in the second measurement process exceed the predetermined range, the first measurement process is performed.

14. A production method of measurement apparatus for reinforcing material conditions, comprising:
arranging an optical fiber with a protective material along a surface of a slope on which a plurality of reinforcing materials are secured, and to pass through a region where the plurality of reinforcing materials are arranged, wherein
the optical fiber with the protective material includes a linear protective material and a first optical fiber,
at least a portion of the first optical fiber is arranged along the longitudinal direction of the linear protective material, and
at least a portion of a surface of the first optical fiber is covered with the linear protective material.

15. The production method of the measurement apparatus for reinforcing material conditions according to claim 14, further comprising:
spraying mortar or concrete to cover the optical fiber with a protective material.
